(19) United States
(12) Patent Application Publication
(10) Pub. No.: US 2003/0104841 A1
(43) Pub. Date: Jun. 5, 2003

(54) Method for displaying time-stamp associated and weighted data and mobile station using the same

(76) Inventor: Katsuaki Yamamoto, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/303,804

(22) Filed: Nov. 26, 2002

(30) Foreign Application Priority Data
Nov. 30, 2001 (JP) 2001-366108

(51) Int. Cl. H04B 1/38; G09G 5/00

(52) U.S. Cl. 455/566; 455/550; 455/575; 345/581; 345/619

(57) ABSTRACT

In a method for displaying time-stamp associated data a difference between a current data and time and the time-stamp of the time-stamp associated data is calculated. Then, a weight is calculated in accordance with the difference. Finally, the time-stamp associated data is displayed with a display mode which is changed in accordance with the weight.

### BACKGROUND OF THE INVENTION

1. Field of the Invention

The present invention relates to a method for displaying time-stamp associated data and a mobile station such as a mobile telephone and a personal digital assistant (PDA) using such a method.

2. Description of the Related Art

Generally, in a prior art mobile station, received mail data, transmission mail data and preserved mail data are associated with time-stamps, and such time-stamp associated mail data are stored in a storing unit. When displaying the time-stamp associated mail data, the time-stamp associated mail data are sorted and rearranged in an ascending order on a data-and-time basis in accordance with the time-stamps thereof. This will be explained later in detail.

In the above-described mobile station, however, it is difficult to intuitively determine how old each of the displayed mail data is. Particularly, when only a part of the mail data to be displayed are displayed or when a single mail data is displayed, it is quite difficult to intuitively determine how old the displayed mail data is.

### SUMMARY OF THE INVENTION

It is an object of the present invention to provide a method for displaying time-stamp associated data capable of intuitively determining how old displayed data is, and a mobile station using the same method.

According to the present invention, in a method for displaying time-stamp associated data, a difference between a current data and time and the time-stamp of the time-stamp associated data is calculated. Then, a weight is calculated in accordance with said difference. Finally, the time-stamp associated data is display with a display mode which is changed in accordance with the weight.

### BRIEF DESCRIPTION OF THE DRAWINGS

The present invention will be more clearly understood from the description set forth below, as compared with the prior art, with reference to the accompanying drawings, wherein:

FIG. 1 is a block circuit diagram illustrating a prior art mobile station;

FIG. 2 is a diagram showing an example of the data displayed on the display unit of FIG. 1;

FIG. 3 is a block circuit diagram illustrating an embodiment of the mobile station according to the present invention;

FIG. 4 is a flowchart showing the operation of the weight calculating unit of FIG. 3;

FIG. 5 is a flowchart showing the operation of the display data generating unit of FIG. 3;

FIG. 6 is a diagram showing an example of display image of the display unit of FIG. 3;

FIG. 7 is a diagram showing another example of display image of the display unit of FIG. 3; and

FIG. 8 is a diagram showing a still other example of display image of the display unit of FIG. 3.

### DESCRIPTION OF THE PREFERRED EMBODIMENT

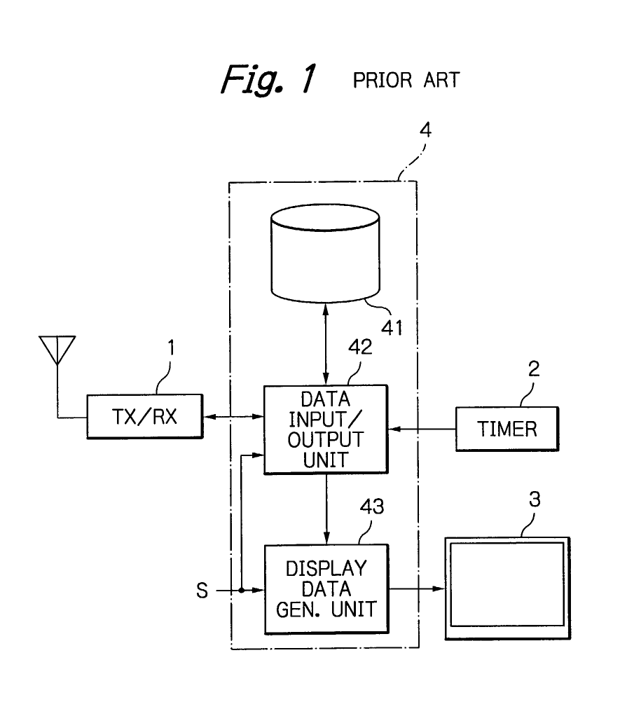

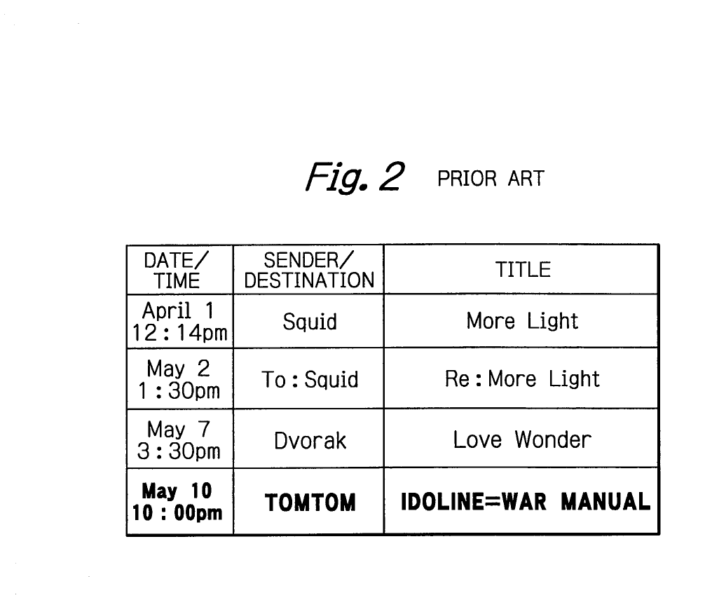

Before the description of the preferred embodiment, a prior art mobile station will be explained with reference to FIGS. 1 and 2.

In FIG. 1, which illustrates a prior art mobile station, the mobile station is constructed by a transceiver unit 1, a timer 2 for generating the current data and time, a display unit 3, and a control unit 4 provided between the transceiver unit 1, the timer 2 and the display unit 3.

The control unit 4 is constructed by a microprocessor which includes a storing unit 41, a data input/output unit 42 and a display data generating unit 43.

For example, when mail data is received by the transceiver unit 1, the data input/output unit 42 reads the current data and time from the timer 2 and stores the mail data associated with the current date and time in the storing unit 41. That is, time-stamp associated mail data is stored in the storing unit 41. On the other hand, when mail data is to be transmitted, the data input/output unit 42 reads the current data and time from the timer 2 and stores the mail data associated with the current data and time in the storing unit 41.

When a display indicating signal S is input by the user, the data input/output unit 42 and the display data generating unit 43 are operated to display a list of mail data as shown in FIG. 2 on the display unit 3. That is, the data input/output unit 42 reads all the mail data stored in the storing unit 41 and transmits them to the display data generating unit 43. Then, the display data generating unit 43 sorts the mail data and rearranges them in an ascending order on a data-and-time basis. Finally, the display data generating unit 43 displays the sorted and rearranged mail data on the display unit 3. Note that unread received mail data is represented by thick characters to attract the user's attention.

In the mobile station of FIG. 1, however, since the displayed mail data are uniform except for unread mail data, it is difficult to intuitively determine how old each of the displayed mail data as shown in FIG. 2 is. Particularly, when only a part of the mail data to be displayed are displayed or when a single mail data is displayed, it is quite difficult to intuitively determine how old the displayed mail data is.

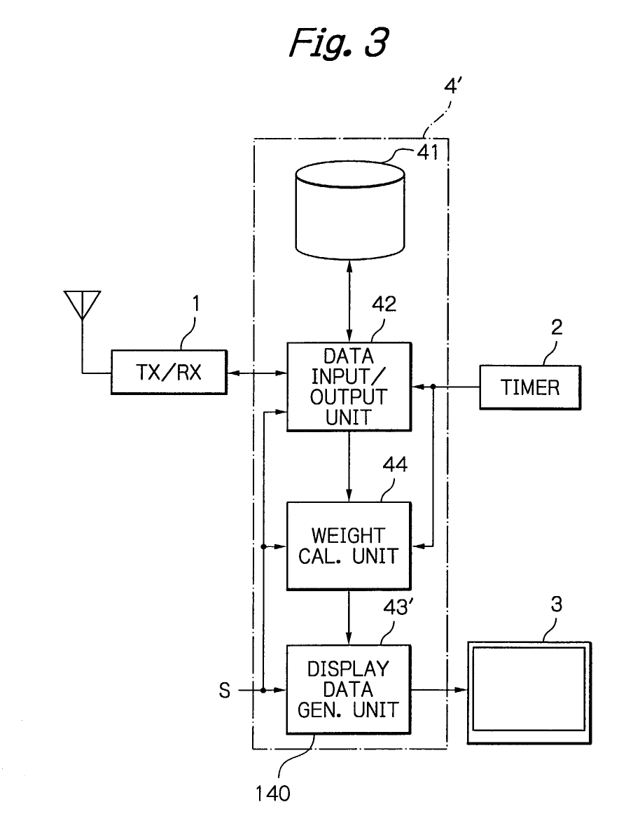

In FIG. 3, which illustrates an embodiment of the mobile station according to the present invention, the control unit 4 of FIG. 1 is modified to a control unit 4′. That is, in the control unit 4′, display data generating unit 43 of FIG. 1 is modified to a display data generating unit 43′ and a weight calculating unit 44 is added.

The weight calculating unit 44 calculates a weight W for each of the displayed mail data in accordance with a difference between the data and time of each of the displayed mail address and the current data and time of the timer 2. In this case, the larger the difference, the larger the weight W.

The display data generating unit 43′ sorts the mail data and rearranges them in an ascending order on a data-and time basis in the same way as the display data generating unit 43 of FIG. 1. Additionally, the display data generating unit 43′ changes the display modes of the displayed mail data in accordance with the weight W thereof.

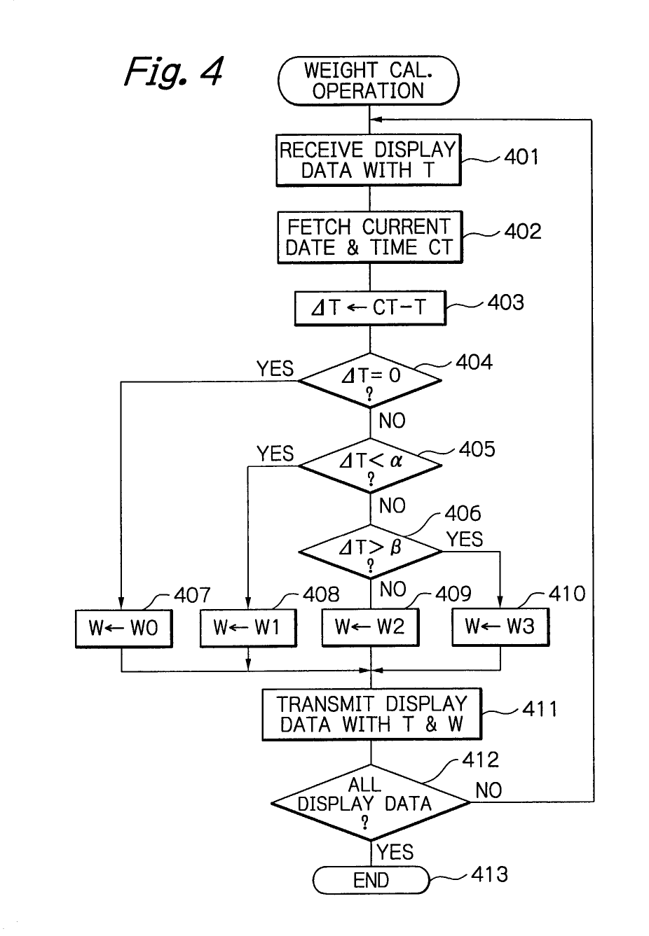

The operation of the weight calculating unit 44 of FIG. 3 is explained next with reference to a flowchart of FIG. 4. Note that the flowchart of FIG. 4 is started by inputting a display indicating signal S by the user.

First, at step 401, one display data with a time-stamp T is read from the storing unit 41 via the data input/output unit 42.

Next, at step 402, the current data and time CT is read from the timer 2.

Next, at step 403, a difference ΔT between the current data and time CT and the time-stamp T is calculated, i.e.,

ΔT←CT−T

In this case, the time component of ΔT is rounded. Otherwise, the time components of CT and T are rounded in advance.

Next, at step 404, it is determined whether or not ΔT is 0 day; at step 405, it is determined whether or not ΔT is smaller than a predetermined value α(>0); and at step 406 , it is determined whether or not ΔT is larger than a predetermined value β(>α). For example, α is 7 days and β is 30 days.

When ΔT=0, the control proceeds to step 407 which causes a weight W to be W0.

When 0<ΔT<α, the control proceeds to step 408 which causes the weight W to be W1 (>W0).

When α<ΔT<β, the control proceeds to step 409 which causes the weight W to be W2 (>W1).

When ΔT≧β, the control proceeds to step 410 which causes the weight W to be W3 (>W2).

The control at steps 407, 408, 409 and 410 proceed to step 411 which transmits the display data with the time-stamp T and the weight W to be display unit 43′.

Step 412 repeats the control at steps 401 through 411 for all the data to be displayed.

The routine of FIG. 4 is completed by step 413.

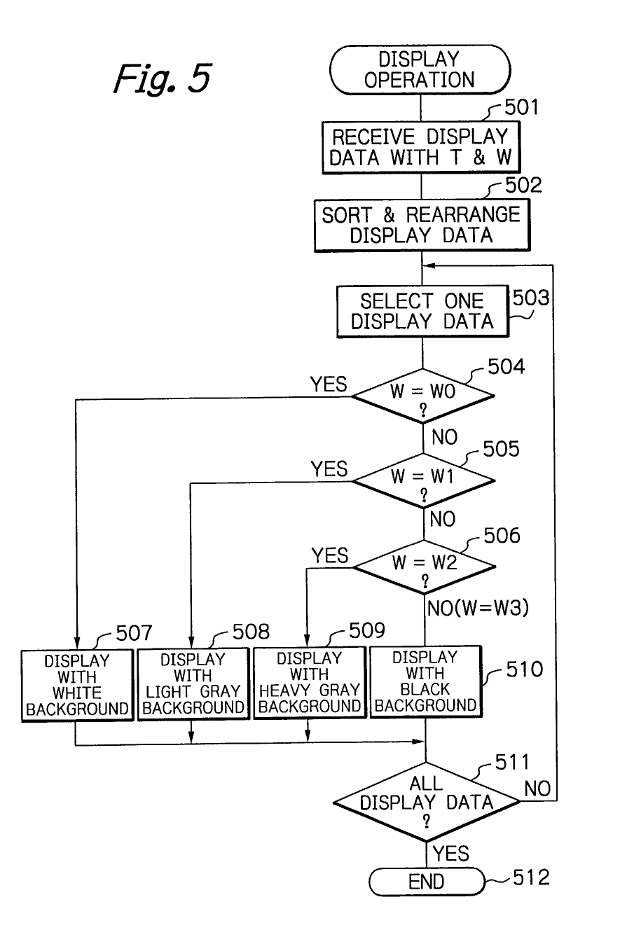

The operation of the display data generating unit 43′ of FIG. 3 is explained next with reference to a flowchart of FIG. 5. Note that the flowchart of FIG. 5 is also started by inputting a display indicating signal S by the user.

First, at step 501, the display data generating unit 43′ receives all the display data with the time-stamps T and the weight W from the weight calculating unit 44.

Next, at step 502, all the display data are sorted and rearranged in an ascending order on a data-and-time basis.

Next, at step 503, one of the display data is selected.

Next, at step 504, it is determined whether or not the weight W of the selected display data is W0; at step 505, it is determined whether or not the weight W of the selected display data is W1; and at step 506, it is determine whether or not the weight W of the selected display data is W2.

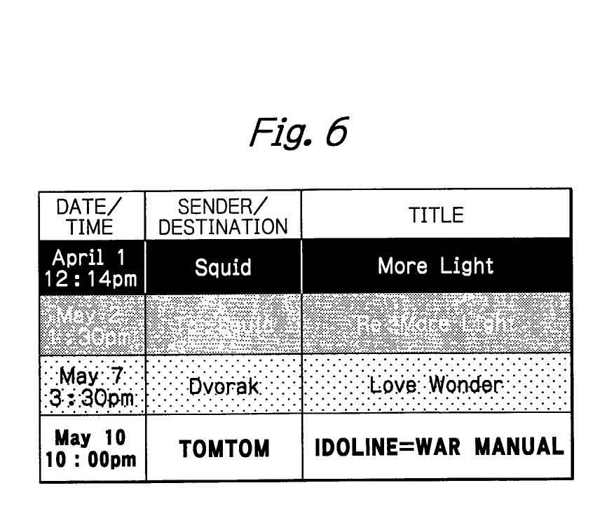

When W=W0, the control proceeds to step 507 which displays the selected data with the time-stamp T with a white background (see: item 4 of FIG. 6).

When W=W1, the control proceeds to step 508 which displays the selected data with the time-stamp T with a light gray background (see: item 3 of FIG. 6).

When W=W2, the control proceeds to step 509 which displays the selected data with the time-stamp T with a heavy gray background (see: item 2 of FIG. 6).

When W=W3, the control proceeds to step 510 which displays the selected data with the time-stamp T with a black background (see: item 1 of FIG. 6).

Step 511 repeats the control at steps 503 through 510 for all the display data.

Thus, the flowchart of FIG. 5 is completed by step 512.

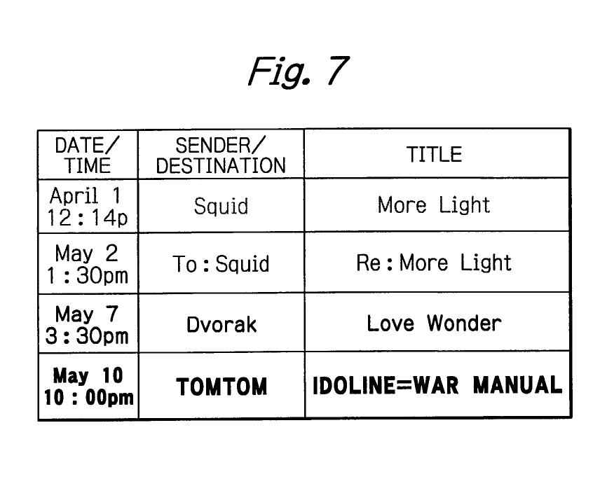

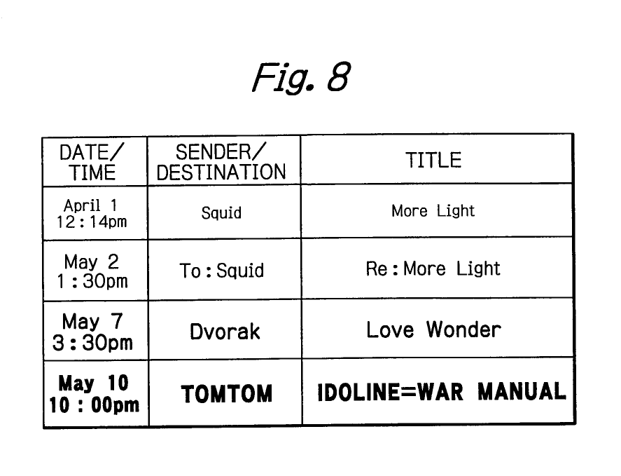

In the above-described embodiment, although the background brightness of display data is changed in accordance with the weight W thereof, the background color of display data can be changed in accordance with the weight W. Also, the thickness degree of characters of display data can be changed in accordance with the weight W thereof as shown in FIG. 7. Further, the size of characters of display data can be changed in accordance with the weight W as shown in FIG. 8. Further, the inclination degree of characters of display data can be changed in accordance with the weight W thereof. Further, two or more of the background brightness, the background color, the thickness degree, the size and the inclination degree can be changed in accordance with the weight W. In any display mode, the latest data is most visibly displayed.

As explained hereinabove, according to the present invention, since the background brightness of displayed data or the like is changed in accordance with how old the displayed data is, it is intuitively determined how old the displayed data is.

1. A method for displaying time-stamp associated data comprising the steps of:
calculating a difference between a current data and time and the time-stamp of said time-stamp associated data;
calculating a weight in accordance with said difference; and
displaying said time-stamp associated data with a display mode changed in accordance with said weight.

2. The method as set forth in claim 1, wherein said display mode is a background brightness of said displayed time-stamp associated data.

3. The method as set forth in claim 1, wherein said display mode is a background color of said displayed time-stamp associated data.

4. The method as set forth in claim 1, wherein said display mode is a thickness degree of characters of said displayed time-stamp associated data.

5. The method as set forth in claim 1, wherein said display mode is a size of characters of said displayed time-stamp associated data.

6. The method as set forth in claim 1, wherein said display mode is an inclination degree of characters of said displayed time-stamp associated data.

7. The method as set forth in claim 1, wherein said display mode is a combination of at least two of a background brightness of said displayed time-stamp associated data, a background color of said displayed time-stamp associated data, a thickness degree of characters of said displayed time-stamp associated data, a size of characters of said displayed time-stamp associated data and an inclination degree of characters of said displayed time-stamp associated data.

8. A method for displaying time-stamp associated data with a display mode in accordance with the time-stamp of said time-stamp associated data.

9. A mobile station comprising:
a storing unit;
a data input/output unit for writing time-stamp associated data in said storing unit and reading said time-stamp associated data from said storing unit;
a weight calculating unit for receiving said time-stamp associated data from said storing unit via said data input/output unit to calculate a weight in accordance with a difference between a current data and time and the time-stamp of said time-stamp associated data; and
a display data generating unit for receiving said time-stamp associated data with said weight to display said time-stamp associated data with a display mode changed in accordance with said weight.

10. The mobile station as set forth in claim 9, wherein said display mode is a background brightness of said displayed time-stamp associated data.

11. The mobile station as set forth in claim 9, wherein said display mode is a background color of said displayed time-stamp associated data.

12. The mobile station as set forth in claim 9, wherein said display mode is a thickness degree of said displayed time-stamp associated data.

13. The mobile station as set forth in claim 9, wherein said display mode is a size of characters of said displayed time-stamp associated data.

14. The mobile station as set forth in claim 9, wherein said display mode is an inclination degree of characters of said displayed time-stamp associated data.

15. The mobile station as set forth in claim 9, wherein said display mode is a combination of at least two of a background brightness of said displayed time-stamp associated data, a background color of said displayed time-stamp associated data, a thickness degree of characters of said displayed time-stamp associated data, a size of characters of said displayed time-stamp associated data and an inclination degree of characters of said displayed time-stamp associated data.

16. The mobile station as set forth in claim 9, being a mobile telephone.

17. The mobile station as set forth in claim 9, being a personal digital assistant.
